(19) United States
(12) Patent Application Publication
(10) Pub. No.: US 2022/0388835 A1
(43) Pub. Date: Dec. 8, 2022

(54) AN ARTIFICIAL FEATHER FILLING MATERIAL

(71) Applicant: IKEA Supply AG, Pratteln (CH)

(72) Inventors: Anders BERGNER, Halmstad (SE); Jeffrey Scott HAGGARD, Cocoa, FL (US); Angel Antonio DE LA HOZ, Melbourne, FL (US)

(21) Appl. No.: 17/762,082

(22) PCT Filed: Sep. 18, 2020
(86) PCT No.: PCT/SE2020/050873

§ 371 Date: Mar. 20, 2022

(30) Foreign Application Priority Data
Sep. 20, 2019 (SE) 1951062-7

(51) Int. Cl. B68G 1/00; A41G 11/00

(52) U.S. Cl. CPC B68G 1/00; A41G 11/00; B68G 2001/005

(57) ABSTRACT

An artificial feather filling material. The material comprises artificial feathers (1), Each of the feathers (1) comprises a first sheet (20) of a first nonwoven material, A filament (10) is arranged along one extension of the sheet and the fiber is bonded to the first sheet.

### TECHNICAL FIELD

The present invention relates to an artificial feather filling material to be used in e.g. pillow and quilts, to replace, or at least supplement, natural feathers. Further, the invention relates to a method for producing such an artificial feather filling material. Furthermore, the invention relates to an apparatus for producing such an artificial feather filling material.

### BACKGROUND

Feathers and down from birds have for long been used as filling material in pillows and quilts. Further, feathers and down have been used as insulation in clothes, e.g. jackets. Especially in pillows, the resilient properties of feathers are more important than their insulation properties. The opposite is applicable in clothing. Further, also down contributes to the resilient properties of pillow, as they provide a memory effect.

Given their origin, various attempts have been made in that art to find alternatives to feathers and down from birds. Some of these alternatives have been drawn to feather or down like materials, thus focusing on structural similarity, whereas others have focused on function in the first place. Numerous materials have indeed been provided as an alternative to down for insulation in clothing. However, such materials, while having good insulation properties, have found less use as filling material for pillows and quilts, in particular for pillows. Further, the functional properties provided by feathers in filling materials are quite distinct from the properties provided by down. As already mentioned, the resilient but still soft feeling provided by feathers in pillows is a desired property.

It would thus be desired to provide an artificial feather filling material to be used in e.g. pillow and quilts, to replace, or at least supplement, natural feathers in such applications.

In the art, some examples of artificial feathers and downs are known. In EP 0 620 185 A1, a thermal insulating unit comprising an elongate support member having a linear density of from about 5 to 150 mg/m and having attached thereto a generally dispersed array of discrete fine fibers having diameters of from about 1.0 to 25.0 micrometers is disclosed. An assembly of the thermal insulating units is alleged to provide a very low-density filling material having thermal and mechanical properties similar to that of natural down. As already mentioned, the mechanical properties of down is distinct from the ones of feathers. Further, U.S. Pat. No. 4,259,400 discloses a fibrous padding material simulating natural down for quilted articles. The material is in the form of an element of defined length and of low thickness relative to its width. The element comprises a central filiform core to which are bonded fibers, which are oriented substantially transversely relative to this core to form barbs extending from the core. Similar to EP 0 620 185 A1, also U.S. Pat. No. 4,259,400 is drawn to artificial down. In U.S. Pat. No. 4,259,400, it is stated that the artificial down may replace down and provide comparable bulk and insulation.

Thus, there is a need in the art for artificial feathers to be used as filling material in e.g. pillows and quilts.

### SUMMARY

Accordingly, there is, according to a first aspect, provided an artificial feather filling material. The artificial feather filling material comprises artificial feathers. According to an embodiment, the artificial feather filling material is used to fill a pillow, a quilt, a sleeping bag, or cushion member. Another aspect relates to an article, such as a pillow, a quilt, a sleeping bag, or cushion member, filled with the present artificial feather filling material.

The artificial feathers of the artificial feather filling material comprises a first sheet of a first nonwoven material. A filament is arranged along one extension of said sheet. Typically, the sheet is a strip. The strip may be an essentially rectangular strip. Though a rectangular strip may be square, it is typically longer than it is wide. For a strip, the filament may be arranged centrally along the extension, e.g. the longitudinal extension, of the strip. The filament may be a monofilament, providing a very similar feeling and function as the corresponding part of a natural feather. Further, the filament is bonded to the first sheet. The combination of a more rigid central filament and a sheet of a nonwoven material provides an artificial feather with resilient properties similar to the ones of natural feathers. By supplementing the resilient properties of the filament with a nonwoven material, i.e. a bonded material, also having some resilient properties, the resilient properties are improved. The nonwoven material typically has a surface weight of less than 100 g/m². Further, the nonwoven material is thin. Its thickness may be 1 mm or less.

The size of the artificial feather may vary. The feather may be 10 to 100 mm, such as 20-80 mm, such as at least 40 mm, such as less than 80 mm, or even less than 70 mm, or even 40 to 60 mm, long. A too short feather provides less resilience. On the contrary, a too long feather provides too much resilience and may be experienced as stiff. Further, the width of the artificial feather may be 5 to 50 mm, such as 10-40 mm, or 15 to 25 mm. A too wide feather will suffer from its higher weight. Further, a too wide feather interacts less properly with other feathers, and/or down, and the synergistic effect sought may even be lost. As already described, the artificial feather may be rectangular. The resilient properties for a rectangular, artificial feather are more comfortable and combines better with down than quadratic artificial feather. The artificial feather having a rectangular shape may have a longer extension in a direction along the filament, than in a direction perpendicular to the filament. However, to more closely resemble a feather, one, or both ends, of the artificial feather may be triangular. By trimming the end(s) of a rectangular strip, triangular end(s) may be provided.

According to an embodiment, the filament, which may be centrally arranged, has the shape of an arc, i.e. the filament is curved. By providing a curved filament, the resilient properties of the artificial feather is further improved. The arc may be a circular arc. The radius of such a circular arc may be 25 to 400 mm, such as 50 to 200 mm. In terms of producing the artificial feather filling material, it may be preferred if the material arc is a circular arc. A method for producing the artificial feather filling material is outlined further below. The method typically comprises a calender, which may be operated to curve the filament.

Further, the artificial feather may also be curved in an extension not parallel, but e.g. perpendicularly, to the filament, which may be centrally arranged. By curving the artificial feather in a further extension, the resilient properties may be further improved. Further, an artificial feather being curved in one or more extensions, will be less dense and provide a less compact filling, thereby giving higher filling power. According to an embodiment, the cross-section of the sheet, perpendicular to the extension of the filament, which may be centrally arranged, is curved at, at least one side of the filament, but typically at both sides. The curvature of the curved cross-section of the sheet may have the shape of circular arc. The radius of such a circular arc may be 25 to 250 mm, such as 40 to 150 mm.

While the artificial feather may comprise only one sheet, such as a strip, of a nonwoven material, it is preferred to provide the artificial feather as a sandwich construction, wherein the filament is arranged between the first sheet of a nonwoven material and a second sheet of a nonwoven material. Such sandwich construction will improve the resilient properties further. Furthermore, the feeling of the filament will be less apparent when embedded between two nonwoven materials. In addition, the risk of separating the filament from the first sheet of a nonwoven material is decreased. According to an embodiment, the artificial feather thus comprises a second sheet, such as a strip, of a second nonwoven material. The filament may be arranged in between the first and the second sheets of nonwoven material(s). The filament is bonded, such as melt bonded, also to the second sheet.

Furthermore, the first sheet may be bonded, such as melt bonded, to the second sheet. By binding the first and the second sheets of nonwoven material(s) to each other, the resilient properties are further improved. Furthermore, also the structural integrity of the artificial feather is improved. In addition, the mechanical strength in the bond between the monofilament and nonwoven is improved. The bonding of the first sheet of nonwoven material to the second sheet may be at discrete locations, at parts of the total area of the sheets, or over the entire area of the sheets. According to an embodiment, the first sheet is bonded to the second sheet. The bonding may take the form of a multitude of bonding lines. The bonding lines may be straight lines. Further, the multitude of bonding lines are typically not parallel with the extension of the filament. Furthermore, the bonding lines are typically neither perpendicular to the extension of the filament. According to an embodiment, the bonding lines are arranged to resemble the barbs in natural feathers, whereby forming feather like, fish-bone pattern together with the filament, which preferably is arranged centrally.

As already described, the sheet(s) of nonwoven material(s) in the artificial feather provides resilient properties to the artificial feather. Nonwoven materials are known to the skilled person. They are fabric-like material comprising fibers bonded together. As recognized by the skilled person, a nonwoven is a sheet of fibers, continuous filaments, or chopped yarns of any nature or origin, that have been formed into a web by any means, and bonded together by any means, with the exception of weaving or knitting. Further information regarding nonwoven may be found in the ISO standard 9092:2019. In the present artificial feather, thin nonwoven materials are typically employed. The nonwoven material may be nonwoven material according to the definition in the ISO standard 9092:2019. According to an embodiment, the first nonwoven material, and/or the second nonwoven material, has a surface weight of 1 to 50 g/m², such as 5 to 30 g/m². If the artificial feather is provided as a sandwich construction, the first nonwoven material, and the second nonwoven material may be the same kind of material. However, the second sheet may also be of another nonwoven material than the first sheet. This may provide the artificial feather with other resilient properties.

According to an embodiment, the first nonwoven material, and/or the second nonwoven material is a spunbonded nonwoven, i.e. spunlaid, heat-bonded nonwoven. The nonwoven material may also be bonded by water entanglement. While less preferred due to the somewhat greater thickness, the nonwoven material may also be bonded by needling. Further, the nonwoven material may also be bonded by a chemical bonding agent i.e. as a “resin” added as powder for thermal activation or a dissolved resin applied by spraying or in a foulard. Furthermore, combinations of bonding methods may also be used, e.g. water entanglement and thermal or resin bonding.

The fibers in the first nonwoven material, and/or the second nonwoven material, are typically thin fibers, as the employed nonwoven material(s) typically is/are thin (the thickness of the fibers defines the minimum thickness of the nonwoven material). The fibers are typical polymer fibers. Various polymers may be used in a fiber for the nonwoven material. The polymer may be a polyester, a polyamide, or a olefin. Specific examples of polymers comprise PET (polyethylene terephthalate), PBT (polybutylene terephthalate), PTT (polytrimethylene terephthalate), PEF (polyethylene furanoate), PLA (polylactic acid), PA 6, PA 11, PA 12, PA 4,6, PA 4,10, PA 5,10, PA 6,6, PA 6,10, PA 6,12, PA 12,12, PP (polypropylene), PE (polyethylene), and co-polymers thereof.

According to an embodiment, the first nonwoven material, and/or the second nonwoven material, comprises fibers having a linear density of 0.5 to 10 dtex, such as 1 to 5 dtex. According to an embodiment, the first nonwoven material, and/or the second nonwoven material, such as a spunbond or meltblown nonwoven material, comprises fibers having an average diameter of 0. 1 μm to 30 μm. A spunbond nonwoven material may comprise fibers having an average diameter of at least 5 μm, such as 5 μm to 30 μm, or even less than 20 μm, such as 10 to 20 μm. A meltblown nonwoven material may comprise fibers having an average diameter of at least 0.1 μm, such as at least 0.25 μm, or 0. 1 μm to 15 μm, such as 0.25 to 10 μm or 1 to 5 μm. To improve the bonding strength between the filament and first nonwoven material, and/or the second nonwoven material, the nonwoven material may comprise a bonding fiber, e.g. a bi-component fiber comprising one bonding polymer with lower melting point than the other component. The bi-component fiber may be sheath-core bi-component fiber. In a bonding fiber in form of a sheath-core bi-component fiber, the sheath may comprise a polymer having a melting point of at least 20° C. lower than the melting point of a polymer in the core. The core may comprise a polyester and have a melting point of at least 220° C. Further, the sheath may have a melting point of less than 200° C., such as between 110° C. and 190° C. The surface weight of the first nonwoven material, and/or the second nonwoven material, may be 1 to 50 g/m², such as 5 to 30 g/m², or 5 to 20 g/m², or even 8 to 15 g/m². A nonwoven material with too low surface weight may not provide sufficient resilience to provide the desired comfort. However, an artificial feather filling material, comprising a nonwoven material with too high surface weight may be experienced as heavy and dense.

The filament is typically somewhat thicker to provide the desired resilient properties. Its largest cross-sectional dimension may be 0.05 to 1 mm, such as 0.1 to 0.6 mm. Typically, the cross-section of the filament is circular. For a filament having a circular cross-section, the diameter may be 0.05 to 1 mm, such as 0.1 to 0.8 mm, or 0.4 to 0.6 mm. A too thin filament may not provide sufficient resilience to provide the desired comfort. The filament may be a hollow filament, such as a hollow bi-component fiber. A hollow filament is lighter, such as 25 to 50% lighter, than a solid monofilament with corresponding diameter. Still a hollow filament may provide the desired resilient properties. However, the flex properties of a hollow filament are somewhat different from the ones of a solid filament. Actually, it was found at least in some embodiments, that the feel of an artificial feather with a hollow filament arranged along one extension of the strip, such as centrally along the longitudinal extension of the strip, may match the feel of the natural feather better than that of an artificial feather with a solid filament.

In order to facilitate bonding of the filament to the sheet(s) of nonwoven material, the filament may be a bi-component fiber, such as a sheath-core bi-component fiber. In an embodiment, according to which the filament is a sheath-core bi-component fiber, the core may comprise a polyester and have a melting point of at least 220° C. Further, the sheath may have a melting point of less than 200° C., such as between 110° C. and 190° C.

In the art, natural down and feathers are typically combined to provide the desired resilience and comfort. Similarly, the artificial feather filling material disclosed herein may thus comprise down as well, in addition to the artificial feathers. While the down may be natural bird down, the down is preferably artificial down. Various kinds of artificial down are known in the art (e.g. U.S. Pat. No. 3,892,909, EP 0 067 498, and U.S. Pat. No. 5,851,665). The artificial feather filling material may comprise 5 to 95% by weight of artificial feathers and 5 to 95% by weight of down. Typically, the artificial feather filling material, similar to natural filling materials, comprises more down than artificial feathers. e.g. a higher weight proportion of down than of artificial feathers. Thus, the artificial feather filling material may comprise 5 to 50% by weight of artificial feathers and 50 to 95% by weight of down. According to an embodiment, the artificial feather filling material comprises 10 to 30% by weight of artificial feathers, the balance being down. While the artificial feathers typically consist a minor proportion in the artificial feather filling material, they are still important to provide the desired properties, e.g. resilience; especially the when used in pillows.

According to an embodiment, the artificial feather filling material further comprises artificial down clusters. Each of the down clusters comprises a number of filaments arranged side by side in a bundle. The filaments in the bundle are bonded, e.g. melt bonded, together at one bonding location. In order to increase the bulk of the bundles, the filaments may be crimped. Further, the position of the bonding location may differ between the down clusters. The linear density of the filaments of the artificial down may be 1 to 10 denier, such as 2 to 5 denier (i.e. 1.1 to 11 dtex, such as 2.2 to 5.6 dtex). Alternatively, the linear density of the filaments may be 1 to 10 dtex, such as 2 to 5 dtex. The filaments may be 20 to 100 mm long, such as 40 to 80 mm long.

According to a second aspect, there is provided a method of producing an artificial feather filling material. The artificial feather filling material is typically the kind of artificial feather filling material as described herein above. Thus, features of the artificial feather filling material already described in relation to the artificial feather filling material are equally applicable in relation to the method for producing an artificial feather filling material.

The method of producing an artificial feather filling material comprises the steps of:
feeding at least one filament and a first web of a fibrous material to a calender with at least one roller and a heating arrangement for heating the first web;
forming, downstream or upstream of the calender, at least one ribbon from the first web with the filament arranged along the ribbon;
bonding, such as melt bonding, the filament to the fibrous material by the calender; and
cross-cutting the ribbon, comprising the first web of a fibrous material and the filament, to form artificial feathers.

Typically, the method of producing an artificial feather filling material is a continuous process. The first web and the filament(s), respectively may be fed from reels to the calender. The first web of a fibrous material is typically a sheet of a nonwoven material. The first web may be un-bonded web comprising carded fibers to be bound in the calender, but preferably the first web is a sheet of a nonwoven material. Further, the filament arranged along the ribbon is preferably arranged centrally on the ribbon. The formed feather may thus have the filament arranged centrally along one of its extensions, such as the longitudinal extension.

While only one ribbon may be formed in the method, the method typically comprises forming more than one ribbon to increase the efficiency of the process. According to an embodiment at least two filaments, such as 2, 3, 4, 5, 6, 7, 8, 9, 10, or more filaments, are separately arranged in parallel on the first web to be fed to the heated calender. When more than one filament is arranged on the first web, the method further comprises the step of cutting the first web between the filament s before or after, preferably after, the filament s have been bonded to the fibrous material. By cutting the first web between the filaments in the machine direction (the longitudinal direction) at least two ribbons, each ribbon comprising one filament, is provided. Subsequently, each ribbon is crosscut into artificial feathers.

As outlined above, the artificial feather may be provided as a sandwich construction comprising a first and a second nonwoven material, the filament typically being arranged in between the first and the second nonwoven material. According to an embodiment, the filament being fed to the calender is arranged in between the first web and a second web of a fibrous material. The second web is also typically a sheet of a nonwoven material. It may be un-bonded web comprising carded fibers to be bound in the calender, but preferably the second web is a sheet of a nonwoven material.

As already described herein above, the first web, and/or the second web is, according to an embodiment, a nonwoven material, such as a spunbonded nonwoven, i.e. spunlaid, heat-bonded nonwoven. The nonwoven material may also be bonded by water entanglement. While less preferred due to the somewhat greater thickness, the nonwoven material may also be bonded by needling.

In the present method, thin webs are typically employed. According to an embodiment, the first web, and/or the second web, has a surface weight of 1 to 50 g/m², such as 5 to 30 g/m².

In an embodiment, wherein the first web is a sheet of a nonwoven material and/or wherein the second web is a sheet of a nonwoven material, the fibers in the nonwoven material(s) are typically thin fibers, as the employed nonwoven material(s) typically is/are thin (the thickness of the fibers defines the minimum thickness of the nonwoven material). The fibers are typical polymer fibers. Various polymers may be used in a fiber for the nonwoven material. The polymer may be a polyester, a polyamide, or an olefin. Specific examples of polymers comprise PET (polyethylene terephthalate), PBT (polybutylene terephthalate), PTT (trimethylene terephthalate), PEF (polyethylene furanoate), PLA (polylactic acid), PA 6, PA 11, PA 12, PA 4,6, PA 4,10, PA 5,10, PA 6,6, PA 6,10, PA 6,12, PA 12,12, PP (polypropylene), PE (polyethylene), and co-polymers thereof.

According to an embodiment, the first web, and/or the second web, comprises fibers having a linear density of 0.5 to 10 dtex, such as 1 to 5 dtex. To improve the bonding strength between the filament and first web, and/or the second web, the nonwoven material may comprise a bonding fiber, e.g. a bi-component fiber comprising one bonding polymer with lower melting point than the other component. The bi-component fiber may be sheath-core bi-component fiber. In a bonding fiber in form of a sheath-core bi-component fiber, the sheath may comprise a polymer having a melting point of at least 20° C. lower than the melting point of a polymer in the core. The core may comprise a polyester and have a melting point of at least 220° C. Further, the sheath may have a melting point of less than 200° C., such as between 110° C. and 190° C.

According to an embodiment, the calender comprises at least two rotating rollers, i.e. a first and a second roller, for calendering the first web and the filament in between them. According to an embodiment, at least one of the rollers is heated. This may be provided for by providing at least one of the rollers with a heater. The heated roller provides for melt bonding the filament to the fibrous material of the first web. The heating arrangement for heating the first web may also be separate from the rollers. It may for example be an IR-heater or a heat fan to heat the first web and the at least one filament.

In order to improve the resilient properties of the artificial feather, the filament may be provided with the shape of an arc. This may be provided for by arranging the first web and optionally the filament to be in contact with a cooling roller arranged downstream of the heating arrangement, e.g. the heated roller, in calendering the first web and the filament, over at least at least 5%, 10%, 25% or 50% of the circumference of the cooling roller. The radius of the cooling roller may be 25 to 400 mm, such as 50 to 200 mm, thus providing an arc with a corresponding radius. The cooling roller, cools the first web and the filament having been heated by the heating arrangement, thereby providing them with a final configuration.

According to an embodiment, the calender comprises at least two rotating rollers, i.e. a first and a second roller, for calendering the first web and the filament in between them. At least one of the rollers may be heated. This may be provided for by providing at least one of the rollers with a heater. The heated roller provides for melt bonding the filament to the fibrous material of the first web. The calender may further comprise a cooling roller arranged downstream of the heating arrangement, e.g. a roller provided with a heater. The cooling roller, cools the first web and the filament having been heated by the heating arrangement, thereby providing them with a final configuration. In order to affect the resilient properties of the artificial feather, the diameter of the cooling roller may vary along its longitudinal extension. As an example, the cooling roller may be undulating along its longitudinal extension. By employing a cooling roller, whose diameter varies along its longitudinal extension, the cross-section of the ribbon(s) of the first web, as seen in a direction perpendicular to the extension of filament, at each side of the filament becomes curved. The curvature may take the shape of circular arc.

According to an embodiment, the calender comprises at least two rotating rollers, i.e. a first and a second roller, for calendering the first web and the filament in between them. At least one of the rollers may be heated. Further, at least one of the rollers may be embossed. The embossing implies that the first web is provided with a pattern. The pattern may be a multitude of lines. As already described, the pattern may be a feather like, fish-bone pattern. Furthermore, in an embodiment according to which the filament fed to the calender is arranged in between the first web and a second web of a fibrous material, the pattern may be bonding pattern, if the first web is melt bonded to the second web.

According to a third aspect, there is provided an apparatus for producing an artificial feather filling material. The apparatus comprises at least two rotatable rollers, for calendering a first web of a fibrous material and a filament in between them, and a heating arrangement for heating the first web of a fibrous material to be calendered, whereby melt bonding the filament to the first web. Preferably, at least one of the rollers is provided with a heater. However, the heating arrangement for heating the first web may also be separate from the rollers. It may for example be an IR-heater or a heat fan to heat the first web and the at least one filament. Further, the apparatus comprises a first cutting arrangement for cutting the first web into ribbons with at least one filament arranged along each of the ribbons. Preferably, the filament is arranged centrally along each of the ribbons. The first cutting arrangement may be provided with a first cutting edge for cutting the first web. As the first web passes through the first cutting arrangement, the first cutting edge may be stationary. In order to improve the cutting efficiency, the cutting edge may be moveable in a direction perpendicular to the extension of the first nonwoven web material and may thus act in a saw like manner. As the web to be cut typically is a bonded fibrous material, e.g. a nonwoven material, use of a simple eyelet may result in the material being torn apart. The first cutting arrangement is arranged either upstream or downstream, such as downstream, of the rotatable rollers. The first cutting arrangement may also be a laser cutting arrangement. Use of laser to cut the first web into ribbons may require less maintenance as the laser does not become worn out. Further, laser may serve to weld the edges of the ribbon, thereby reducing the risk of possible unwanted fringe forming.

Further, the apparatus comprises a second cutting arrangement. The second cutting arrangement is arranged downstream of the first cutting arrangement and the rotatable rollers. The second cutting arrangement provides for cross-cutting the ribbons into artificial feathers. The second cutting arrangement may be provided with a second cutting edge for cross-cutting the ribbons into artificial feathers. As the ribbons are to be cut in direction not parallel with the longitudinal extension of the ribbons, i.e. machine direction, the second cutting edge is moveable. According to an embodiment, the second cutting edge is moveable in the same direction as the extension of the first nonwoven web material. Typically, the second cutting edge is moveable in a direction perpendicular to the longitudinal extension of the ribbons, i.e. perpendicular to the machine direction. According to an alternative embodiment, the second cutting edge is moveable in a direction perpendicular to the extension of the first nonwoven web material. The second cutting arrangement may be a laser cutting arrangement. Use of laser to cut the ribbons into artificial feathers may require less maintenance as the laser does not become worn out. Further, the laser may serve to weld the edges of the ribbon.

According to an embodiment, the apparatus further comprises a rotatable, cooling roller arranged downstream of the heating arrangement, e.g. a roller provided with a heater. The cooling roller, cools the first web and the filament having been heated by the heating arrangement, thereby providing them with a final configuration. The apparatus is configured to be operated such that the cooling roller is in contact with the first web of the fibrous material and optionally the filament over at least 5%, 10%. 25% or 50% of its circumference in calendering the first web of the fibrous material and the filament. As already described herein above, this provides for improving the resilient properties of the artificial feather filling material.

Further, the diameter of the cooling roller may vary along its longitudinal extension. As an example, the cooling roller may be undulating along its longitudinal extension. As already described herein above, this provides for affecting the resilient properties of the artificial feather filling material.

Furthermore, preferably at least one of the rollers of the calender is embossed.

Although the present invention has been described above with reference to specific embodiments, it is not intended to be limited to the specific form set forth herein. Rather, the invention is limited only by the accompanying claims and other embodiments than the specific embodiments described above are equally possible within the scope of these appended claims.

In the claims, the term “comprises/comprising” does not exclude the presence of other elements or steps. Additionally, although individual features may be included in different claims, these may possibly advantageously be combined, and the inclusion in different claims does not imply that a combination of features is not feasible and/or advantageous.

In addition, singular references do not exclude a plurality. The terms “a”, “an”, “first”, “second” etc. do not preclude a plurality.

### BRIEF DESCRIPTION OF THE DRAWINGS

These and other aspects, features and advantages of which the invention is capable of will be apparent and elucidated from the following description of embodiments of the present invention, reference being made to the accompanying drawings, in which:

FIG. 1 shows a perspective view of an artificial feather according to an embodiment;

FIGS. 2a-c show different views, including two cross-sections (FIG. 2b and FIG. 2c), of the artificial feather in FIG. 1;

FIG. 3 shows a schematic cross section of an apparatus for producing an artificial feather filling material, according to an embodiment;

FIG. 4 shows the apparatus in FIG. 3 seen from above;

FIG. 5a-b show different views of a roller with recesses;

FIG. 6 shows a perspective view of an embossed roller with recesses; and

FIG. 7a-d shows a perspective view of a roller being undulating along its longitudinal extension and its cross-sections (FIG. 7b, FIG. 7c and FIG. 7d).

FIG. 8 shows a photograph of an artificial feather according to an embodiment. The ruler alongside the artificial feather shows its dimensions in centimeters.

### DETAILED DESCRIPTION

The following description focuses on an embodiment of the present invention applicable to an artificial feather filling material. However, it will be appreciated that the invention is not limited to the specific exemplary embodiment described.

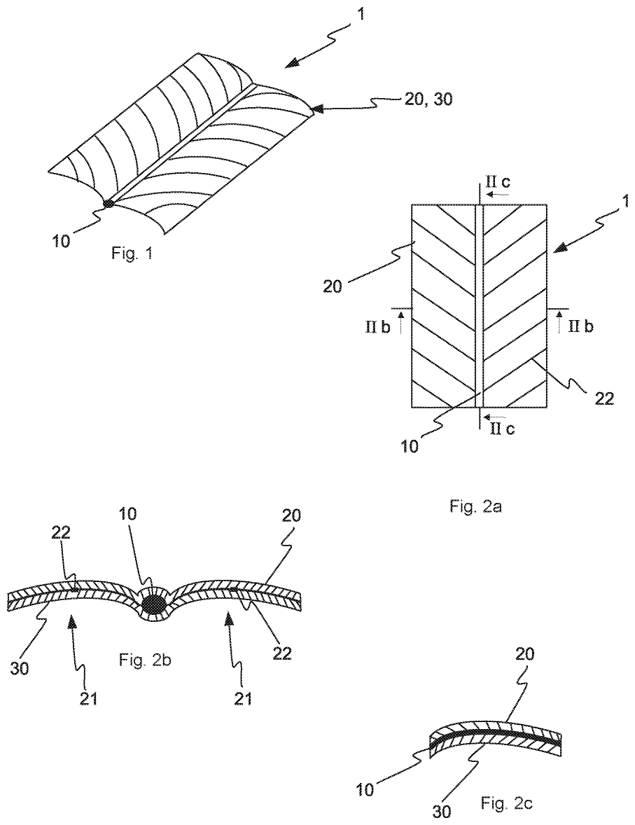

The artificial feather filling material comprises a plurality of artificial feathers 1. As can be seen in FIG. 1, the individual artificial feather 1, according to an embodiment, comprises a first strip 20 of a first nonwoven material. A filament 10, which in the illustrated embodiment is a monofilament, is arranged centrally along one extension, e.g. the longitudinal extension, of the strip 20. The filament 10 is bonded to the first strip 20.

FIG. 2a is a top view of the artificial feather 1 of FIG. 1. FIG. 2b is a cross-section taken along line II b-II b of FIG. 2a, and FIG. 2c is a cross-section taken along line II c-II c of FIG. 2a. As can be seen in FIG. 2b, the artificial feather 1, according to an embodiment, comprises a second strip 30 of a second nonwoven material. The filament 10 is arranged in between the first strip 20 and the second strip 30. Further, the cross-section of the strips 20, 30, perpendicular to the extension of the centrally arranged filament 1, at each side of the centrally arranged filament 1, is curved. The curvature 21 of the curved cross-section of the strips 20, 30 may have the shape of circular arc. Hence, in the perspective of FIG. 2b the artificial feather 1 has a shape resembling that of a flying seagull, as seen from the head. Further, as can be seen in FIG. 2c, the filament 10, according to an embodiment, has the shape of an arc. The curvature 11 of the arc shaped filament 10 may have the shape of a circular arc. Furthermore, as can be seen in FIG. 2a, the first strip 20 may be bonded to the second strip 30 by a multitude of bonding lines 22 arranged to resemble the barbs in natural feathers, whereby forming a forming a feather like, fish-bone pattern together with the centrally arranged filament.

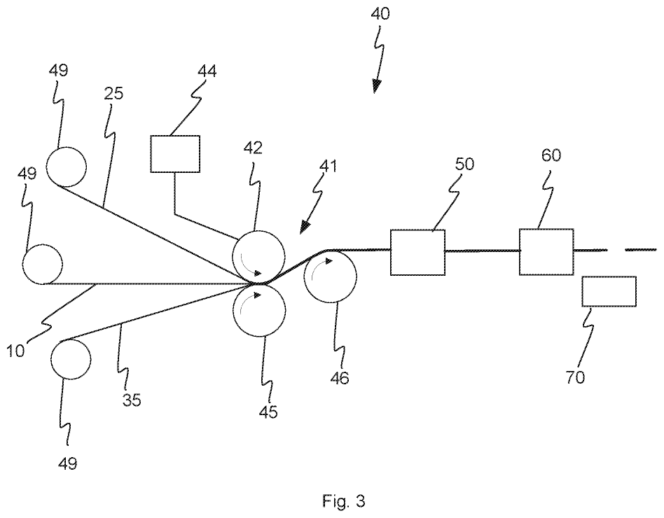

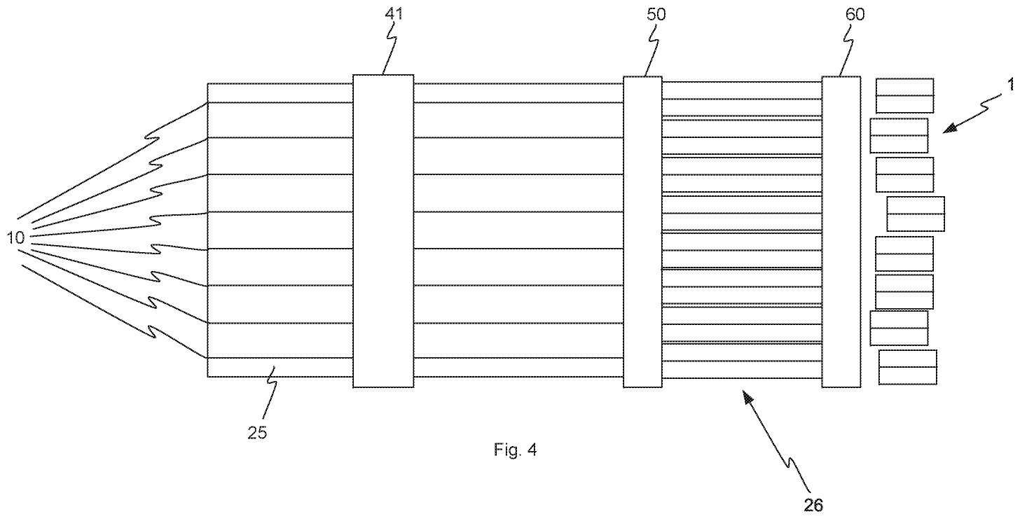

In FIGS. 3 and 4, an apparatus 40 for producing an artificial feather filling material, according to an embodiment, is shown. The apparatus comprises a calender 41 with at least two rotatable rollers 42, 45 and a rotatable, cooling roller 46, arranged downstream of the at least two rotatable rollers 42, 45. A heating arrangement 44 is provided, and in the illustrated embodiment this is accomplished by means of least one of the rollers 42, 45 being provided with a heater 44. The apparatus 40 is arranged for feeding a first web 25 of a fibrous material, a filament 10, and a second web 35 of a fibrous material to the calender 41 from reels 49. The filament 10 may be sheath-core bi-component fiber. The core in the sheath-core bi-component fiber may comprise a polyester (e.g. PET) and have a melting point of approx. 265° C. Further, the sheath, in the sheath-core bi-component fiber, may comprise a co-polyester (e.g. co-PET) and have a melting point of approx. 180° C. The first web 25 of the fibrous material, as well as the second web 35 of a fibrous material, may be PET spunbond of approx. 10 gsm.

In feeding the first web 25, the filament 10, and the second web 35 to the calender 41, the filament 10 is fed between the first web 25 and the second web 35. Further, the calender 41 is arranged for calendering the first web 25, the filament 10, and the second web 35 in between the two rotatable rollers 42, 45. In calendering the first web 25, the filament 10, and the second web 35, the filament 10 is melt bonded to the first web 25 and to the second web 35, respectively. The apparatus 40 further comprises a first cutting arrangement 50 for cutting the first web 25 material, and the second web 35 material if present, into ribbons 26 with one filament 10 arranged centrally at each of the ribbons 26. The first cutting arrangement 50 is arranged downstream of the rotatable rollers 42, 45, but may, in alternative embodiments, be placed upstream of the rotatable rollers 42, 45, or may even be integrated in the rotatable rollers 42, 45. Typically, the cooling roller 46 is arranged upstream of the first cutting arrangement 50. After having passed the heating arrangement 44 to melt bond the filament 10 to the first web 25, the first web 25 and the filament 10 are brought into contact with the cooling roller 46 to cool them, thereby providing them with an arced configuration. In FIG. 3, the first web 25 and the filament 10 are in contact with the cooling roller 46 over about 10% of the circumference of the cooling roller 46. The contact may however preferably be more than 10% of the circumference of the cooling roller 46.

Furthermore, the apparatus 40 comprises a second cutting arrangement 60 for cross-cutting the ribbons 26 into artificial feathers 1. The second cutting arrangement 60 is arranged downstream of the first cutting arrangement 50 and the rotatable rollers 42, 45. Downstream of the second cutting arrangement 60 a collection station 70 is arranged, which gathers the produced artificial feathers 1 into an artificial feather filling material.

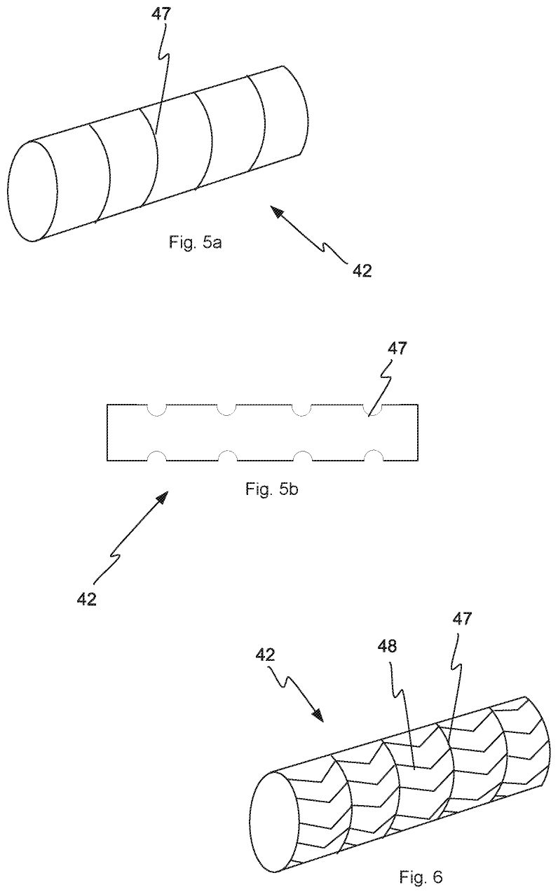

A roller 42, according to an embodiment, is shown in FIG. 5a. The roller 42 is provided with recesses 47 along its perimeter for receiving the filaments 10, being thicker than the first and second web 25, 35. The cross-section (cf. FIG. 5b) of each recess 47 may be semicircular to conform to the filament 10. By providing at least one of the rotatable rollers 42, 45 with recesses along its perimeter for receiving the filaments 10, the calendering of the first and second web 25, 35 becomes more effective if the filament 10 not separates the rotatable rollers 42, 45. Further, the recesses 47 should be sufficiently shallow to allow for the filaments 10, the first web 25, and second web 35 to be pressed together in calendering them.

A roller 42, according to another embodiment, is shown in FIG. 6. Apart from the recesses 47 shown in FIG. 5, the roller 42 is embossed. The embossment serves to provide the artificial feathers 1 with a feather like, fish-bone pattern 48.

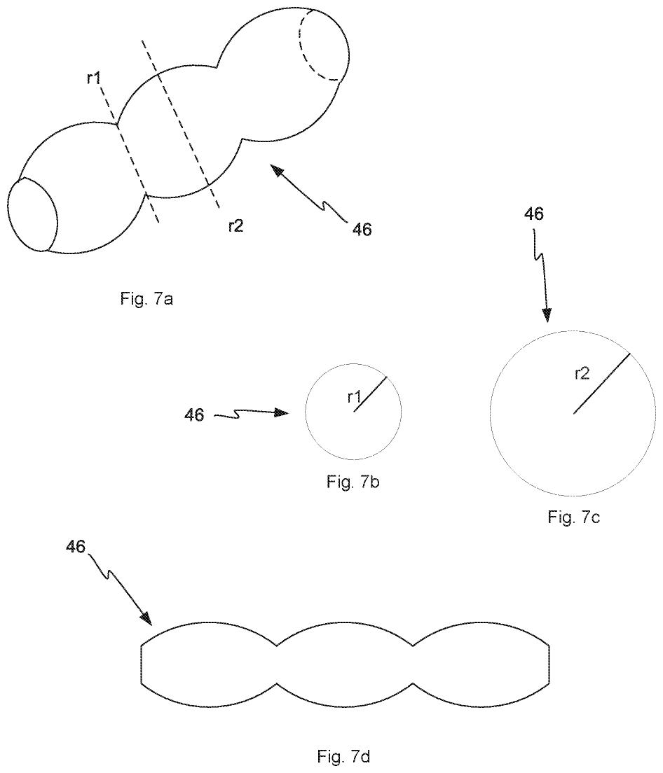

A cooling roller 46, according to another embodiment, is shown in FIG. 7a-d. The radius (r₁, r₂) of the cooling roller 46 varies along its longitudinal extension (cf. FIGS. 7b and 7c, showing two radial cross-sections of the cooling roller 46), the cooling roller 46 being undulating along its longitudinal extension (cf. FIG. 7d showing a longitudinal cross-section of the cooling roller 46).

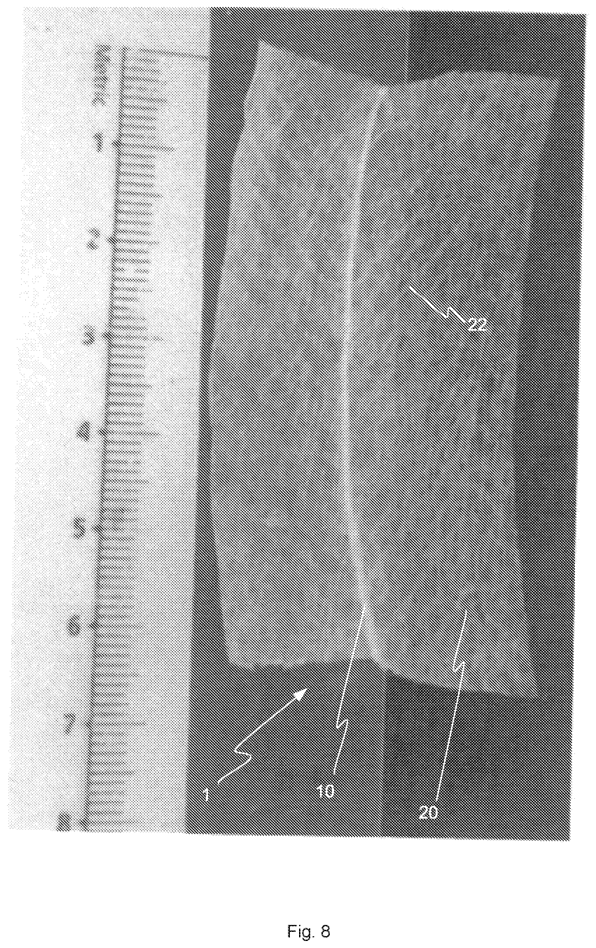

In FIG. 8, a photograph of an artificial feather according to an embodiment related to the one in FIG. 2 is provided. The first strip 20 of the first nonwoven material and the filament 10 are indicated in the photograph. Further, one the bonding lines 22 has also been indicated. This feather is about 60 mm long and about 36 mm wide. The non-woven is a 10 m/m² spunbond.

In order to provide an artificial feather filling material for a pillow, the artificial feather in FIG. 8 may be combined with artificial down according to e.g. example 2 in U.S. Pat. No. 5,851,665 (cf. FIG. 1B therein). In combining artificial feathers and artificial down to provide an artificial filling material for e.g. a pillow, a higher weight proportion of down than of artificial feathers is typically used. Thus, an artificial filling material for e.g. a pillow may comprise about 20% by weight of artificial feathers and 80% by weight of artificial down. The proportion of artificial down may in some embodiments be even higher, such as up to 95% by weight.

1. An artificial feather filling material, comprising artificial feathers each comprising a first sheet of a first nonwoven material, wherein a filament is arranged along one extension of said sheet, the filament being bonded to the first sheet, wherein the first sheet is a strip, the filament being arranged along the longitudinal extension of said strip.

2. The artificial feather filling material according to claim 1, wherein the filament is arranged centrally along the longitudinal extension of said strip; and/or wherein the filament is melt bonded to the first sheet of a first nonwoven material.

3. The artificial feather filling material according to claim 1, wherein the artificial feather further comprises a second sheet, in the form of a strip, of a second nonwoven material, the filament being arranged in between the first and the second sheets of nonwoven material(s), wherein the filament is bonded also to the second sheet, the first sheet being bonded to the second sheet.

4. The artificial feather filling material according to claim 3, wherein the first sheet is bonded to the second sheet, the bonding taking the form of a multitude of bonding lines.

5. The artificial feather filling material according to claim 1, wherein the first nonwoven material, and the second nonwoven material, if present:
has a surface weight of 1 to 50 g/m²; and/or
is a spunbonded and/or meltblown nonwoven; and/or
comprises fibers having a linear density of 0.5 to 10 dtex; and/or comprises fibers having an average diameter of 0.1 μm to 30 μm for spunbonded nonwoven, or 0.1 μm to 15 μm for a meltblown nonwoven.

6. The artificial feather filling material according to claim 1, wherein the filament is a bi-component fiber, and/or the filament is hollow; and/or wherein the filament has a largest cross-sectional dimension of 0.05 to 1 mm.

7. The artificial feather filling material according to claim 6, wherein the filament is a sheath-core bi-component fiber, the sheath comprising a polymer having a melting point of at least 20° C. lower than the melting point of a polymer in the core; the core comprising a polyester having a melting point of at least 220° C., and the sheath having a melting point of less than 200° C.

8. The artificial feather filling material according to claim 1, wherein the filament has the shape of an arc.

9. The artificial feather filling material according to claim 1, wherein the cross-section of the first sheet perpendicular to the extension of the filament, at each side of the filament, is curved.

10. The artificial feather filling material according to claim 1, wherein the artificial feather filling material further comprises artificial down.

11. The artificial feather filling material according to claim 10, wherein the artificial feather filling material further comprises artificial down clusters, wherein each of the down clusters comprises a number of filaments arranged side by side in a bundle, the filaments being melt bonded together at one bonding location.

12. An article filled with the artificial feather filling material according to claim 1, the article being selected from the group consisting of a pillow, a quilt, a sleeping bag, and a cushion member.

13. A method of producing an artificial feather filling material, said process comprising the steps of:
feeding at least one filament and a first web of a fibrous material to a calender with at least one roller and a heating arrangement for heating the first web;
forming, downstream or upstream of the calender, at least one ribbon from the first web with the filament arranged centrally along the ribbon;
bonding the filament to the fibrous material by the calender; and
cross-cutting the ribbon and the filament to form artificial feathers.

14. The method of producing an artificial feather filling material according to claim 13, wherein the the filament being fed to the calender is arranged in between the first web and a second web of a fibrous material.

15. The method of producing an artificial feather filling material according to claim 13, wherein the calender comprises at least two rotating rollers for calendering the first web and the filament in between them, at least one of the rollers being heated, the calender further comprising a cooling roller arranged downstream of the at least one roller being heated, wherein the calender is arranged such that the first web and optionally the filament is in contact with the cooling roller over at least at least 5% of its circumference in calendaring them, whereby providing the filament with the shape of an arc.

16. The method of producing an artificial feather filling material according to anyone of claim 13, wherein the calender comprises at least two rotating rollers for calendering the first web and the filament between them, at least one of the rollers being heated, the calender further comprising a cooling roller arranged downstream of the at least one roller being heated, wherein the diameter of the cooling roller varies along its longitudinal extension, whereby the cross-section of the ribbon(s), as seen in a direction perpendicular to the extension of filament, at each side of the filament being curved.

17. The method of producing an artificial feather filling material according to claim 13, wherein the calender comprises at least two rotating rollers for calendering the first web and the filament between them, at least one of the rollers being heated, wherein at least one of the rollers is embossed, whereby the first web is provided with a pattern; the first web being melt bonded to a second web of a fibrous material, if the filament being fed to the calender is arranged in between the first web and a second web of a fibrous material.

18. The method of producing an artificial feather filling material according to claim 13, wherein at least two filaments are separately arranged in parallel on the first web to be fed to the heated calender, the method further comprising the step of cutting the first web between the filaments after the filaments have been bonded to the first web, whereby providing at least two ribbons, each ribbon comprising one filament, wherein the at least two ribbons are being cut into artificial feathers subsequently to cutting the first web between the filaments.

19. An apparatus for producing an artificial feather filling material, the apparatus comprising at least two rotatable rollers for calendering the first web of a fibrous material and a filament in between them and a heating arrangement for heating the first web of a fibrous material to be calendered, whereby melt bonding the filament to the first web, the apparatus further comprising a first cutting arrangement for cutting the first web into ribbons with one filament arranged along each of the ribbons, the first cutting arrangement being arranged either upstream or downstream of the rotatable rollers, and a second cutting arrangement, arranged downstream of the first cutting arrangement and the rotatable rollers, for cross-cutting the ribbons into artificial feathers.

20. The apparatus according to claim 19, wherein the apparatus further comprises a cooling roller arranged downstream of the heating arrangement, the apparatus being configured to be operated such that the cooling roller is in contact with the first web of the fibrous material and optionally the filament over at least 5% of its circumference in calendering the first web of the fibrous material and the filament; optionally at least one of the rollers of the calender being embossed.

21. (canceled)
